(19) United States
(12) Patent Application Publication
(10) Pub. No.: US 2015/0316920 A1
(43) Pub. Date: Nov. 5, 2015

(54) POSITIONING APPARATUS AND POSITIONING METHOD

(71) Applicants: Kazuki YAMANAKA, (US); Junji YAMAMOTO, (US); Koichi KAKIMOTO, (US)

(72) Inventors: Kazuki YAMANAKA, Tokyo (JP); Junji YAMAMOTO, Tokyo (JP); Koichi KAKIMOTO, Tokyo (JP)

(73) Assignee: Mitsubishi Electric Corporation, Tokyo (JP)

(21) Appl. No.: 14/648,331

(22) PCT Filed: Dec. 25, 2012
(86) PCT No.: PCT/JP2012/083424

§ 371 Date: May 29, 2015

(51) Int. Cl. G05B 19/402; G05B 15/02

(52) U.S. Cl. CPC G05B 19/402; G05B 15/02; G05B 2219/37627

(57) ABSTRACT

A positioning apparatus is provided that starts positioning control according to output of a positioning command in accordance with input of an external input signal from an external sensor. The positioning apparatus includes an external input unit, a timer unit that counts a period of time that starts when the external input signal is input to the external input unit, a memory that stores a setting timer value that is set, using a positioning control program, as delay time for delaying the start of the positioning control and positioning command data calculated by an arithmetic processing unit, and a positioning command output unit that output the positioning command on the basis of the positioning command data stored in the memory to a target to be controlled. The positioning command output unit outputs the positioning command when a count value of the timer unit agrees with the setting timer value retained in the memory. The setting timer value stored in the memory is changeable in accordance with setting in the positioning control program.

### FIELD

The present invention relates to a positioning apparatus and a positioning method, and particularly relates to a positioning apparatus mounted on a programmable logic controller (PLC).

### BACKGROUND

As a positioning apparatus mounted on a PLC an apparatus is known that starts positioning control (positioning start) in accordance with the input of signals from an external sensor. The timing of positioning start varies with the timing at which signals are input from the external sensor. In establishing a positioning system that starts the positioning in accordance with the input from an external sensor, it is required that the external sensor is mounted at a precise position so that the positioning is started at a desired timing.

In a conventional method of determining the position of an external sensor, at first a tentative position is determined for the external sensor, and, then, the positioning system is actually operated to check the positioning start timing according to the input from the external sensor. If the positioning is not started at a desired timing, the physical position of the external sensor is changed, and, then, the positioning system is operated again to check the positioning start timing. The process of changing the position of the external sensor and checking the positioning start timing is repeated to bring the positioning start timing closer to the desired timing until the position of the external sensor is finalized. An external sensor is often threadably mounted with screws. Thus, these screws need to be untightened and tightened every time the position of an external sensor is changed until its position is finalized. In the process of determining the position of the external sensor, the oftener the position of an external sensor is changed the longer the time required to start up a positioning system becomes.

In a conventional positioning system that starts the positioning according to the input from an external sensor, the position the external sensor is mounted and the timing the positioning is started correspond with each other on a one-to-one basis. To update the positioning start timing after the position of the external sensor has once been determined, the position of the external sensor needs to be readjusted. Furthermore, when a plurality of positioning start timings are needed to be set in a single positioning system, the number of external sensors to be mounted must correspond to the number of timings to be set. The more the external sensors to be mounted are required, the higher the cost of the positioning system becomes. As a solution to these problems with the conventional technique, there is a demand for the capability of freely adjusting the timing to start the positioning regardless of the position of an external sensor.

As a method of adjusting a startup timing in a control system, for example, generating a delay trigger to synchronize a plurality of controllers has been proposed for a motion control system in which the plurality of controllers is connected via a network (see Patent Literature 1, for example). In this system, a delay trigger is generated, in which a predetermined delay time is added to a time between a time when an event has occurred and a time when a program is started up.

Additionally, as a method to correct the timing of input from a sensor, for example, correcting a difference in timing of signals from a position detection sensor due to an error in the position of the sensor has been proposed for a motor with the sensor attached thereon (see Patent Literature 2, for example).

### CITATION LIST

### Patent Literature

Patent Literature 1: Japanese Patent Application Laid-Open No. 2007-213474

Patent Literature 2: Japanese Patent Application Laid-Open No. 2006-197762

### SUMMARY

### Technical Problem

Since the technique described in Patent Literature 1 generates a delay trigger in which a predetermined delay time is added to a time of occurrence of an event, it is necessary to provide the information concerning the time of occurrence of the event to a trigger generated according to the detection of the event. To obtain the information on the time of the occurrence, a clock module to measure the absolute time and a clock synchronization module to synchronize the time among the controllers are needed. This technique is problematic in that a delay trigger cannot be generated only from the information of occurrence of an event and that an element is needed to obtain the time of occurrence of the event.

The technique described in Patent Literature 2 is to correct a difference in timing due to an attachment error of a position detection sensor for a motor into which the position detection sensor is incorporated. This technique is not assumed to be applied to the correction of timing of the input from an external sensor. Additionally, since the attachment position of the position detection sensor is unchanged after the shipment of this motor as a product, a difference in timing of the sensor signals is corrected with a fixed correction value. The correction value is set, before the product shipment, as a fixed value that satisfies the product specification for the motor driving current; thus, this method is not applicable to a case where a user is allowed to change the correction value at the discretion of the user after the product shipment.

The present invention has been achieved in view of the above, and an object of the present invention is to provide a positioning apparatus and a positioning method capable of delaying the start of the positioning control regardless of the position where an external sensor is mounted and thereby allowing a positioning system to start up in a short period of time.

### Solution to Problem

To solve the above described problems and achieve the object, the present invention discloses a positioning apparatus mounted on a programmable logic controller and starts positioning control on a target to be controlled by the programmable logic controller. The positioning apparatus is configured to start the positioning control according to output of a positioning command in accordance with input of an external input signal from an external sensor. The positioning apparatus includes: an external input unit that receives the input of the external input signal from the external sensor; a timer unit that counts a period of time that starts when the external input signal is input to the external input unit; an arithmetic processing unit that calculates positioning command data on a basis of a positioning parameter that is set, using a positioning control program, as an operating condition for the device to be controlled; a memory that stores a setting timer value that is set, using the positioning control program, as delay time to delay the start of the positioning control and the positioning command data calculated by the arithmetic processing unit; and a positioning command output unit that outputs the positioning command to the target to be controlled on a basis of the positioning command data stored in the memory. The positioning command output unit outputs the positioning command when a count value of the timer unit agrees with the setting timer value stored in the memory, and the setting timer value stored in the memory is changeable in accordance with setting in the positioning control program.

### Advantageous Effects of Invention

The positioning apparatus according to the present invention is capable of adjusting the timing to output a positioning command in accordance with a setting timer value. The positioning apparatus is capable of freely delaying the start of the positioning by performing simple work of changing a setting timer value, without moving the external sensor. The positioning apparatus eliminates the need to adjust the physical position of the external sensor for making the positioning start timing as desired and thereby makes the positioning system to start up with a short period of work time. The positioning apparatus is capable of updating the positioning start timing by changing the setting timer value without adjusting the position of the external sensor even after the positioning start timing has once been determined. The positioning apparatus, in a positioning system to which a single external sensor is mounted, is also capable of setting a plurality of positioning start timings by changing the setting timer value without changing the position of the external sensor.

### BRIEF DESCRIPTION OF DRAWINGS

FIG. 1 is a block diagram of the configuration of a positioning system including a positioning apparatus according to an embodiment of the present invention.

FIG. 2 is a flowchart of a procedure to adjust the positioning start timing with the positioning apparatus.

FIG. 3 is a flowchart of a procedure to adjust the positioning start timing with a positioning apparatus according to a comparative example.

### DESCRIPTION OF EMBODIMENTS

Exemplary embodiments of a positioning apparatus and a positioning method according to the present invention will now be described in detail with reference to the drawings. This invention is not limited to the embodiments.

### Embodiments

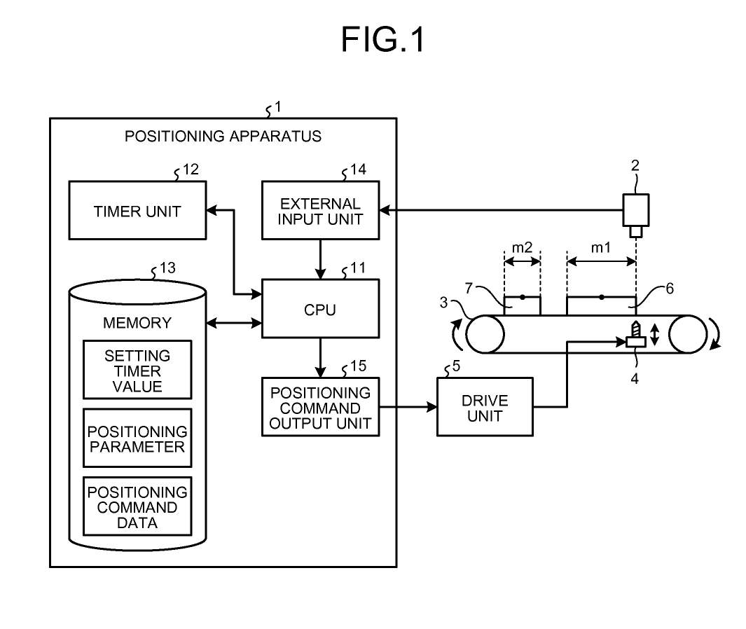

FIG. 1 is a block diagram of an exemplary configuration of a positioning system including a positioning apparatus according to an embodiment of the present invention. A positioning apparatus 1 is provided in a PLC. The configuration of the PLC other than the positioning apparatus 1 is omitted from the drawing.

The positioning apparatus 1 includes a CPU 11, a timer unit 12, a memory 13, an external input unit 14, and a positioning command output unit 15. The CPU 11, the timer unit 12, the memory 13, the external input unit 14, and the positioning command output unit 15 are connected with each other via an internal bus. The configuration of the positioning apparatus 1 may be changed as appropriate.

The CPU 11 functions as an arithmetic processing unit that performs various types of processing. The CPU 11 calculates positioning command data on the basis of a positioning parameter. The positioning parameter is set by a positioning control program, as an operating condition for a target to be controlled by the PLC.

The external input unit 14 receives external input signals from an external sensor 2. The timer unit 12 performs counting with an input from the external sensor 2 as a trigger. The timer unit 12 counts a period of time that starts when an external input signal from the external sensor 2 is input to the external input unit 14.

The memory 13 stores a setting timer value, the positioning parameter, and the positioning command data. The setting timer value is a value that is set by the positioning control program as delay time that delays the start of positioning control (positioning start). The CPU 11 reads out the positioning parameter from the memory 13 for calculating the positioning command data. The memory 13 stores the positioning command data calculated by the CPU 11.

The positioning command output unit 15 outputs a positioning command on the basis of the positioning command data stored in the memory 13 to the target to be controlled. The positioning apparatus 1 starts up the positioning control of the target to be controlled, according to the output of the positioning command in accordance with the input of the external input signal from the external sensor 2.

A positioning method in which the timing to start the positioning is adjusted with the positioning apparatus 1 will be described below. A user sets a positioning parameter, which will be an operating condition for a target to be controlled, such as travel speed and travel time, in the positioning control program. The user also sets a setting timer value, which will be the delay time to delay the start of the positioning, in the positioning control program. The memory 13 stores the positioning parameter and the setting timer value set in the positioning control program.

The CPU 11 reads out the positioning parameter stored in the memory 13. The CPU 11 calculates positioning command data on the basis of the positioning parameter that has been read out. The memory 13 stores the positioning command data calculated by the CPU 11.

Upon the input of an external input signal from the external sensor 2 to the external input unit 14, the timer unit 12 starts counting up from zero with the external input signal as a trigger. The timer unit 12 continues counting up until the count value counted since the external input signal has been input to the external input unit 14 agrees with the setting timer value stored in the memory 13. The positioning command output unit 15 outputs a positioning command when the count value of the timer unit 12 agrees with the setting timer value stored in the memory 13.

The positioning apparatus 1 is capable of changing a setting timer value stored in the memory 13 in accordance with the setting in the positioning control program. The timing the count value of the timer unit 12 reaches the setting timer value may be changed by changing the setting timer value. The positioning apparatus 1 is capable of adjusting the timing the positioning command output unit 15 outputs a positioning command by adjusting the setting timer value.

An exemplary application of the positioning apparatus 1 will now be described with reference to FIG. 1. A hole creating device 4 is a target to be controlled by the PLC. The hole creating device 4 performs a hole creation on subjects to be conveyed 6 and 7. A conveying apparatus 3 conveys the subjects to be conveyed 6 and 7. The length m1 of the subject to be conveyed 6 in a travelling direction on the conveying apparatus 3 and the length m2 of the subject to be conveyed 7 in the travelling direction on the conveying apparatus 3 are assumed to have a relationship of m1>m2.

The external sensor 2 detects the subjects 6 and 7 being conveyed by the conveying apparatus 3. The external sensor 2 is connected to the external input unit 14. A drive unit 5 drives the hole creating device 4. The drive unit 5 is connected to the positioning command output unit 15.

The positioning apparatus 1 positions the hole creating device 4 so as to create a hole, for example, in each of the subjects being conveyed 6 and 7 at their middle portions in the travelling direction on the conveying apparatus 3. The external sensor 2 outputs an external input signal when ends of the subjects being conveyed 6 and 7 have reached a position directly under the external sensor 2. The drive unit 5 drives the hole creating device 4 in accordance with the input of a positioning command from the positioning command output unit 15.

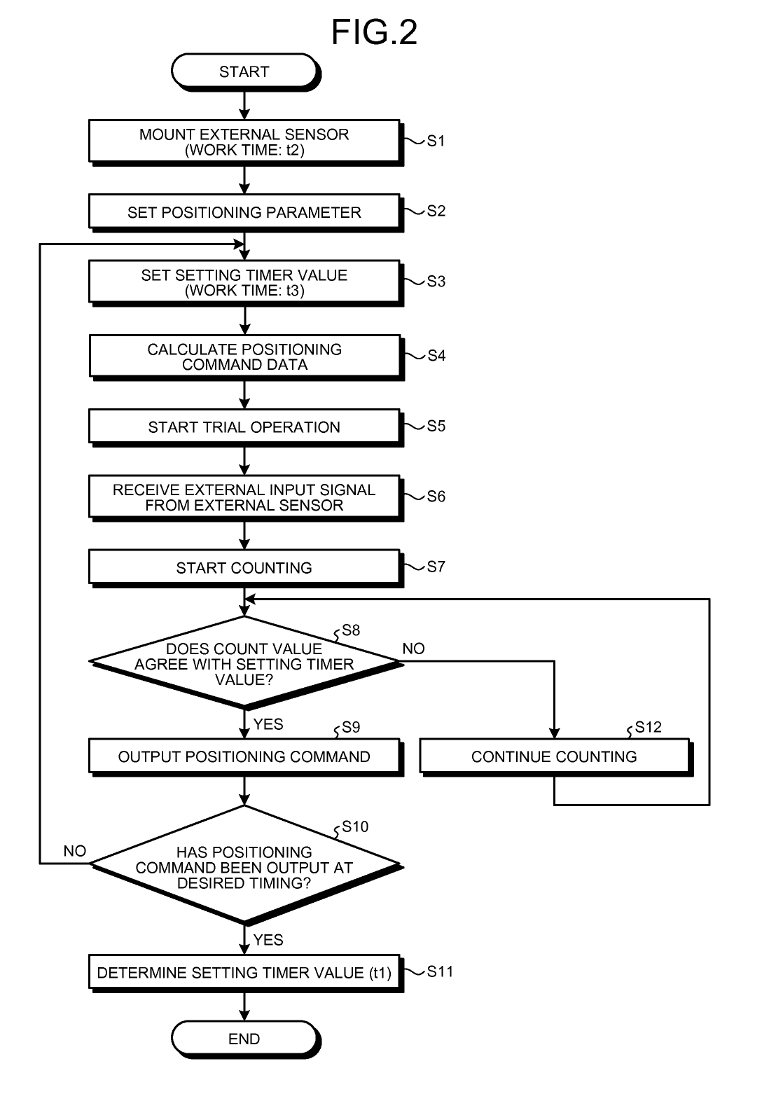

FIG. 2 is a flowchart of a procedure to adjust the timing to start the positioning with the positioning apparatus. To construct a positioning system including the positioning apparatus 1, a user installs the external sensor 2 at a general position above the conveying apparatus 3 (step S1). The user installs the external sensor 2 by, for example, screwing it to the fixing position. It is assumed that it takes work time t2 to install the external sensor 2.

The user sets, in the positioning control program, a positioning parameter relating to a position the hole creating device 4 is moved up and down for hole creation (step S2). Then, the user sets a setting timer value in the positioning control program (step S3). The user sets, for example, zero as an initial value for the setting timer value. The memory 13 stores “0” as the setting timer value. It is assumed that it takes work time t3 to set the setting timer value.

The CPU 11 calculates positioning command data on the basis of the positioning parameter set in step S2 (step S4). The memory 13 stores the positioning parameter set concerning the hole creating device 4 and the positioning command data calculated by the CPU 11.

Then, the user starts a trial operation of the PLC (step S5). The PLC is to perform, for example, the hole creation on the subject to be conveyed 6 as the trial operation. When the end of the subject 6 being conveyed by the conveying apparatus 3 passes vertically under the external sensor 2, the external sensor 2 generates an external input signal in accordance with the detection of the subject being conveyed 6. The external input unit 14 receives the external input signal from the external sensor 2 (step S6).

Upon the input of the external input signal from the external sensor 2 to the external input unit 14, the timer unit 12 starts counting (step S7). In step S8 that follows, the CPU 11 determines whether the count value of the timer unit 12 agrees with the setting timer value stored in the memory 13.

In the case of the trial operation with “0” set as the setting timer value, when the external input signal is detected at the external input unit 14, simultaneously the count value “0” of the timer unit 12 agrees with the setting timer value “0” stored in the memory 13 at “0” (step S8, Yes). When the setting timer value is “0”, the timer unit 12 stops counting before the count value is increased from “0.”

In response to the agreement between the count value of the timer unit 12 and the setting timer value of the memory 13 in step S8, the positioning command output unit 15 outputs a positioning command (step S9). The drive unit 5 moves the hole creating device 4 up and down in accordance with the positioning command from the positioning command output unit 15.

After the up-and-down movement of the hole creating device 4, the user checks to see if, in step S9, the positioning command has been output at a desired timing (step S10). The user checks, for example, visually to see if a hole is created at the middle portion of the subject conveyed 6 to determine whether the positioning command has been output at the desired timing.

If the hole is created at the middle portion of the subject conveyed 6, it is determined that the positioning command has been output from the positioning command output unit 15 at the desired timing (step S10, Yes). The positioning apparatus 1 determines the setting timer value “0” stored in the memory 13 as a setting timer value (referred to as t1) that enables the positioning command to be output at the desired timing (step S11).

If the hole is not created at the middle portion of the subject conveyed 6, it is determined that the positioning command has not been output from the positioning command output unit 15 at the desired timing (step S10, No). The user sets a value other than “0” as a setting timer value in the positioning control program (step S3). Thus, the positioning apparatus 1 changes the setting timer value stored in the memory 13. The memory 13 stores the changed setting timer value. When the setting timer value stored in the memory 13 has been changed, the procedure in step S4 and beyond is repeated.

In the case of the trial operation with the setting timer value other than “0”, the timer unit 12 increases the count value from “0” when the counting is started in step S7. In step S8, the CPU 11 determines whether the count value of the timer unit 12 agrees with the changed setting timer value.

If the count value of the timer unit 12 does not agree with the setting timer value (step S8, No), the timer unit 12 continues counting (step S12). The timer unit 12 continues counting, and when the count value agrees with the setting timer value (step S8, Yes), the positioning command output unit 15 outputs the positioning command (step S9). The drive unit 5 moves the hole creating device 4 up and down in accordance with the positioning command from the positioning command output unit 15.

After the up-and-down movement of the hole creating device 4, the user checks to see whether, in step S9, the positioning command has been output at the desired timing in the present trial operation (step S10). If the positioning command has not been output from the positioning command output unit 15 at the desired timing in the present trial operation again (step S10, No), the positioning apparatus 1 goes back to step S3 to further change the setting timer value, and repeats the procedure in step S4 and beyond.

If the positioning command has been output from the positioning command output unit 15 at the desired timing in the present trial operation (step S10, Yes), the positioning apparatus 1 determines the setting timer value stored in the memory 13 as the setting timer value t1 that enables the positioning command to be output at the desired timing (step S11). When the setting timer value t1 has been determined in step S11, the positioning apparatus 1 finishes the adjustment of the timing to start the positioning.

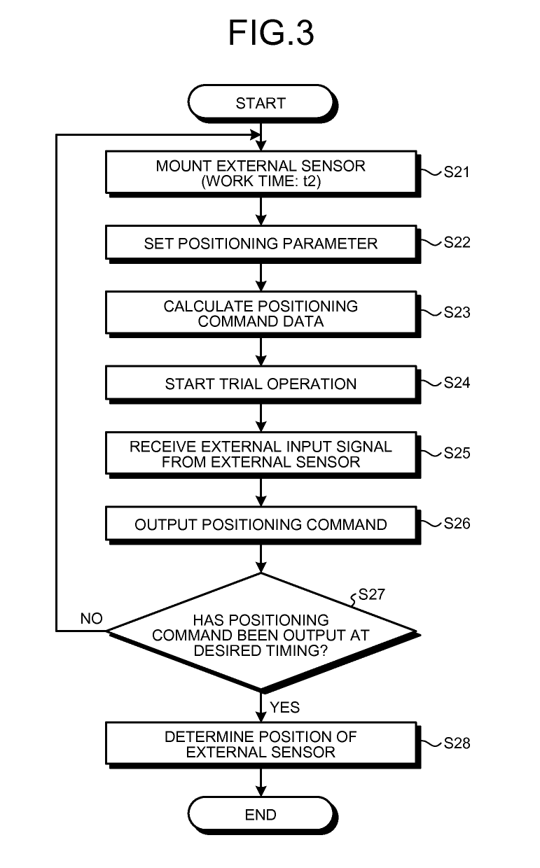

FIG. 3 is a flowchart of a procedure to adjust the timing to start the positioning with a positioning apparatus according to a comparative example of the present embodiment. The positioning apparatus according to the comparative example has a similar configuration to the positioning apparatus 1 according to the present embodiment illustrated in FIG. 1, except that the timer unit 12 is not included and that the memory 13 lacks the storage of a setting timer value. The positioning apparatus according to the comparative example will be described with its components identical with those illustrated in FIG. 1 designated with identical reference characters.

A user installs an external sensor 2 at a general position above a conveying apparatus 3 (step S21). The user installs the external sensor 2 by, for example, screwing it to the fixing position. It is assumed that it takes work time t2 to install the external sensor 2.

The user sets, in a positioning control program, a positioning parameter relating to a position at which a hole creating device 4 is moved up and down for hole creation (step S22). The CPU 11 calculates positioning command data on the basis of the positioning parameter set in step S22 (step S23).

Then, the user starts a trial operation of a PLC (step S24). The PLC performs, for example, the hole creation on a subject to be conveyed 6 as the trial operation. When an end of the subject 6, being conveyed by the conveying apparatus 3, passes vertically under the external sensor 2, the external sensor 2 outputs an external input signal according to the detection of the subject being conveyed 6. The external input unit 14 receives the external input signal from the external sensor 2 (step S25).

Upon the input of the external input signal to the external input unit 14 in step S25, the positioning command output unit 15 outputs a positioning command (step S26). The drive unit 5 moves the hole creating device 4 up and down in accordance with the positioning command from the positioning command output unit 15.

After the up-and-down movement of the hole creating device 4, the user checks to see whether, in step S26, the positioning command has been output at a desired timing (step S27). The user checks, for example, visually to see if a hole is created at the middle portion of the subject conveyed 6 to determine whether the positioning command has been output at the desired timing.

If the hole is created at the middle portion of the subject conveyed 6, it is determined that the positioning command has been output from the positioning command output unit 15 at the desired timing (step S27, Yes). The positioning apparatus 1 determines the position at which the external sensor 2 is temporarily installed as a position of the external sensor 2 at which the positioning command is obtained at the desired timing (step S28).

If the hole is not created at the middle portion of the subject conveyed 6, it is determined that the positioning command has not been output from the positioning command output unit 15 at the desired timing (step S27, No). In this case, the flowchart reverts back to step S21, where the user reinstalls the external sensor 2 by moving thereof from the position installed so far to a different position. When the physical position of the external sensor 2 has been changed in step S21, the procedure in step S22 and beyond is repeated.

In the procedure that applies the positioning apparatus according to the comparative example, if the positioning is not started at a desired timing, the physical position of the external sensor 2 is changed to adjust the timing to start the positioning. In this method, every time the position of the external sensor 2 is changed, the work time t2 in step S21 is needed.

In contrast, in the procedure that applies the positioning apparatus 1 according to the present embodiment, if the positioning is not started at a desired timing, a setting timer value is changed to adjust the timing to start the positioning. In this method, every time the setting timer value is changed, the work time t3 in step S3 illustrated in FIG. 2 is needed.

In the work time t2 needed to change the position of the external sensor 2, screws fixing the external sensor 2 are removed, the position of the external sensor 2 is modified, and the screws are tightened to fix the external sensor 2. In the work time t3 needed to change a setting timer value, the value in the positioning control program is rewritten. In comparison with the work performed in the work time t2, the work performed in the work time t3 can be completed in a shorter period of time; thus, the work time t3 is distinctly shorter than the work time t2 (t2>>t3).

Hence, with the positioning apparatus 1 according to the present embodiment, as the number of times the timing to output a positioning command is modified increases, the period of time until the adjustment of the timing to start the positioning is finished can be significantly reduced in comparison with the comparative example.

According to the positioning apparatus 1, it is possible to freely delay the start of the positioning by performing simple work of changing a setting timer value, without moving the external sensor 2. The positioning apparatus 1 eliminates the need to adjust the physical position of the external sensor 2 for starting the positioning at a desired timing and thus the positioning system can be started up with a shorter period of work time.

In the case where the positioning apparatus according to the comparative example is used to process the subject to be conveyed 6 and the subject to be conveyed 7, which have mutually different lengths, two external sensors are needed in order to output positioning commands at respective timings adjusted to the subjects to be conveyed 6 and 7.

The positioning apparatus 1 according to the present embodiment is capable of setting a setting timer value t1 for the subject to be conveyed 6; and is capable of setting a setting timer value (referred to as t4), which is different from t1, for the subject to be conveyed 7 having a different length from the subject to be conveyed 6. The positioning apparatus 1 is capable of switching between the setting timer values t1 and t4 for the subjects to be conveyed 6 and 7 to thereby output positioning commands at respective timings adjusted to the subjects to be conveyed 6 and 7 with one external sensor 2. The memory 13 may store a plurality of setting timer values. According to the positioning apparatus 1, it is possible to reduce the number of external sensors 2 that need to be installed, and thereby reduce the cost of a positioning system.

The positioning apparatus 1 is capable of changing the setting timer value and thereby updating the timing to start the positioning even after the timing to start the positioning has once been determined, without adjusting the position of the external sensor 2. The positioning apparatus 1 is capable of switching setting timer values and thereby setting a plurality of timings to start the positioning in a positioning system with the one external sensor 2 installed, without changing the position of the external sensor 2. A positioning system can be established so as to be capable of processing a plurality of subjects to be conveyed having different shapes by changing the setting timer value, for example, to t1 for processing the subject to be conveyed 6 and to t4 for processing the subject to be conveyed 7.

A positioning apparatus 1 may include a plurality of positioning command output units 15. Each of the positioning command output unit 15 is connected to a drive unit 5. By connecting different processing devices to each drive unit 5, a positioning system capable of handling different types of processing can be constructed.

To allow the positioning system capable of handling different types of processing to start the positioning with the input of external input signals from an external sensor 2 to the positioning apparatus 1, a memory 13 stores: positioning parameters, which will be operating conditions for the each drive unit 5; positioning data calculated by a CPU 11 on the basis of the positioning parameters; and setting timer values for adjusting the timings to output positioning commands to the each drive unit 5. The positioning apparatus 1 is capable of outputting positioning commands based on the positioning command data stored in the memory 13 at timings in accordance with the setting timer values stored in the memory 13, in response to the external input signals from the external sensor 2. According to the present invention the positioning apparatus 1 may be made so expandable as to be able to output positioning commands at respectively adjusted timings in response to the inputs from the one external sensor 2. According to the positioning apparatus 1, the adjustment of the timing to start the positioning in the present embodiment may be applied to the adjustment of the timing to stop the positioning control or of the timing to change the control or a control condition.

### INDUSTRIAL APPLICABILITY

As described above, the positioning apparatus and the positioning method according to the present invention are suitable to start the positioning control in accordance with the input from an external sensor.

### REFERENCE SIGNS LIST

1 positioning apparatus, 2 external sensor, 3 conveying apparatus, 4 hole creating device, 5 drive unit, 6 and 7 subjects to be conveyed, 12 timer unit, 13 memory, 14 external input unit, 15 positioning command output unit.

1. A positioning apparatus mounted on a programmable logic controller and starts positioning control on a target to be controlled by the programmable logic controller, the positioning apparatus configured to start the positioning control according to output of a positioning command in accordance with input of an external input signal from an external sensor, the apparatus comprising:
an external input unit that receives the input of the external input signal from the external sensor;
a timer unit that counts, in inside of the positioning apparatus, a period of time that starts when the external input signal is input to the external input unit to adjust timing to output the positioning command;
an arithmetic processing unit that calculates positioning command data on a basis of a positioning parameter that is set, using a positioning control program, as an operating condition for the device to be controlled;
a memory that stores a setting timer value that is set, using the positioning control program, as delay time to delay the start of the positioning control and the positioning command data calculated by the arithmetic processing unit; and
a positioning command output unit that outputs the positioning command to the target to be controlled on a basis of the positioning command data stored in the memory, wherein
the positioning command output unit outputs the positioning command when a count value of the timer unit agrees with the setting timer value stored in the memory, and
the setting timer value stored in the memory is changeable in accordance with setting in the positioning control program.

2. A positioning method in which positioning control is started on a target to be controlled by a programmable logic controller and the positioning control is started as a positioning apparatus mounted on the programmable logic controller outputs a positioning command in accordance with input of an external input signal, the method comprising:
receiving the input of the external input signal;
counting, in inside of the positioning apparatus, a period of time that starts when the external input signal is input to adjust timing to output the positioning command;
calculating positioning command data on a basis of a positioning parameter that is set, using a positioning control program, as an operating condition for the target to be controlled;
storing in a memory a setting timer value that is set, using the positioning control program, as delay time to delay the start of the positioning control; and
outputting the positioning command on a basis of the positioning command data to the target to be controlled, wherein
the positioning command is output when a count value indicating the period of time that starts when the external input signal is input agrees with the setting timer value stored in the memory, and
the setting timer value stored in the memory is changeable in accordance with setting in the positioning control program.
